(19) United States
(12) Patent Application Publication
(10) Pub. No.: US 2002/0149677 A1
(43) Pub. Date: Oct. 17, 2002

(54) Digital camera with communications functionality

(76) Inventor: Michael Wright, Kansas City, MO (US)

Correspondence Address: HOVEY WILLIAMS TIMMONS & COLLINS, 2405 GRAND BLVD., SUITE 400, KANSAS CITY, MO, 64108

(21) Appl. No.: 10/118,715

(22) Filed: Apr. 9, 2002

Related U.S. Application Data
(60) Provisional application No. 60/282,507, filed on Apr. 9, 2001.

(51) Int. Cl. H04N 5/225

(52) U.S. Cl. 348/207.1; 348/231.3

(57) ABSTRACT

A digital camera (10) operable to capture, modify, and transfer a plurality of digital images to an Internet website (12) where the images may be viewed with an Internet web browser, the camera (10) comprising an image capture module (22) for capturing the images, a memory module (24) for storing the images, an image modification module (26) for modifying the images, a code generation module (28) for encapsulating the images in browser compatible code, an output module (30) for connecting to and transferring the code to the website (12) through a service provider (16). The camera (10) also includes an update module (32) for updating information stored in the camera (10). Additionally, the camera (10) may include an output capable of direct connection to a computer monitor and/or a television and an input capable of direct connection to a keyboard and/or a mouse.

### RELATED APPLICATIONS

This application claims priority of a provisional patent application titled “Digital Camera With Communications Functionality”, Ser. No. 60/282,507 filed Apr. 9, 2001, hereby incorporated into the present application by reference.

### BACKGROUND OF THE INVENTION

1. Field of the Invention

The present invention relates to digital cameras. More particularly, the present invention relates to a digital camera that allows a user to create, modify, and transfer a plurality of digital images to an Internet website where the images may be viewed with an Internet web browser.

2. Description of Prior Art

Traditional digital cameras require expensive memory modules in order to store large numbers of images. Additionally, commonly available digital cameras do not include capabilities to modify images or transfer images to an Internet website.

In order to modify images or transfer images to an Internet website, users are required to transfer images to a personal computer (PC). Requiring users to have access to a PC increases the costs associated with these cameras. Furthermore, transferring images to a PC typically requires users to overcome complicated settings and cabling issues between the camera and the PC.

For these reasons, it is often difficult for users to store large numbers of images, modify images, or transfer images to an Internet website where they may be shared with family and friends. Therefore, users often become frustrated with and discontinue use of these cameras.

Accordingly, there is a need for an improved digital camera that overcomes the limitations of the prior art.

### SUMMARY OF THE INVENTION

The present invention overcomes the above-identified problems and provides a distinct advance in the art. More particularly, the present invention provides a digital camera that allows a user to create, modify, and transfer a plurality of digital images to an Internet website where the images may be viewed with an Internet web browser.

The preferred camera is capable of capturing, modifying, and transferring a plurality of digital images to a website residing on the Internet. The camera preferably transfers the images to the website through a wireless connection to one of a plurality of wireless communications towers operated by one or more wireless communication service providers. Additionally, the camera may be connected to a personal computer (PC), which is primarily used to update information stored in the camera.

The camera broadly comprises an image capture module for capturing the images, a memory module for storing the images, an image modification module for modifying the images, a code generation module for encapsulating the images in a block of browser compatible code, an output module for connecting with and transferring the block of code to the website through the service provider. The camera also includes an update module for updating information stored in the camera.

The image capture module is preferably similar to that of commonly available digital cameras and is activated by a shoot button that is preferably mounted on top of the camera. Specifically, the image capture module is operable to create each digital image file representative of an object or objects the user wishes to capture when the shoot button is depressed and store the digital image files in the memory module.

The memory module includes a utility section and an application section. The utility section is used to store the image files. The application section is preferably used to store information, such as, an IP address of the website. The application section may also be used to store pre-configured code segments for use with the browser. Information stored in the application section can preferably only be updated by the update module through either the PC or the output module.

The image modification module is used to modify a plurality of characteristics of each image according to input received from the user either through the control buttons, the keyboard, or the PC. The characteristics preferably include resolution, size, shape, pan, zoom, and orientation of the image.

The code generation module is used to generate the block of code for use with the browser and is activated by a transfer button mounted on the camera. The block of code preferably includes the digital image files and may also include the code segments stored in the application section of the memory module.

The output module is used to connect the camera 10 with the cellular service provider and preferably includes an antenna and a CDMA and/or GPRS modem. The output module connects with the website at the IP address stored in the application section of the memory module through the antenna, tower, and the service provider. This connection is also initiated by depressing the transfer button. Once this connection has been established, the output module sends the block of code received from the code generation module to the website.

The update module is used to update information stored in the application section of the memory module, such as, the IP address and the code segments. The updated information will be used by the code generation module and the output module on the next and subsequent instances when the transfer button is depressed. Alternatively, in order to use the updated information, it may be necessary to turn the camera off and then back on, thereby allowing the camera to reinitialize with the updated information.

In use, the user captures the image by aiming the camera at the object he or she wishes to capture and depressing the shoot button. The image capture module creates and stores the digital image file representative of the object in the utility section of the memory module. The image is then displayed on a view screen where the user may view the image.

If the user wishes, he or she may modify the image. The user may adjust the resolution of the image using a plurality of control buttons. The user may also crop the image adjusting the size and/or shape of the image using the control buttons. The user may also zoom and/or pan adjusting the center of the image using the control buttons. The user may also rotate the image adjusting the orientation of the image using the control buttons. When the user is done making modifications, the modified image is stored in the memory module.

When the user wishes to transfer images to the website, he or she initiates the transfer by depressing the transfer button. The code generation module retrieves any code segments stored in the application section of the memory module. The code generation module then creates the block of code comprising the images according to the code segments. The output module then searches for the tower operated by the service provider with the antenna. Once contact is established with the service provider, the output module attempts to establish a connection with the website at the IP address stored in the application section of the memory module. The output module then sends the block of code received from the code generation module to the website through the cellular service provider. The user may then view the images on the website using the browser through the Internet.

### BRIEF DESCRIPTION OF THE DRAWINGS

A preferred embodiment of the present invention is described in detail below with reference to the attached drawing figures, wherein:

FIG. 1 is a block diagram of a preferred embodiment of a digital camera that allows a user to create, modify, and transfer a plurality of digital images to an Internet website where the images may be viewed with an Internet web browser;

FIG. 2 is a block diagram of the camera;

FIG. 3 is a flow chart showing a method of creating and modifying the images; and

FIG. 4 is a flow chart showing a method of transferring the images to the website.

### DETAILED DESCRIPTION OF A PREFERRED EMBODIMENT

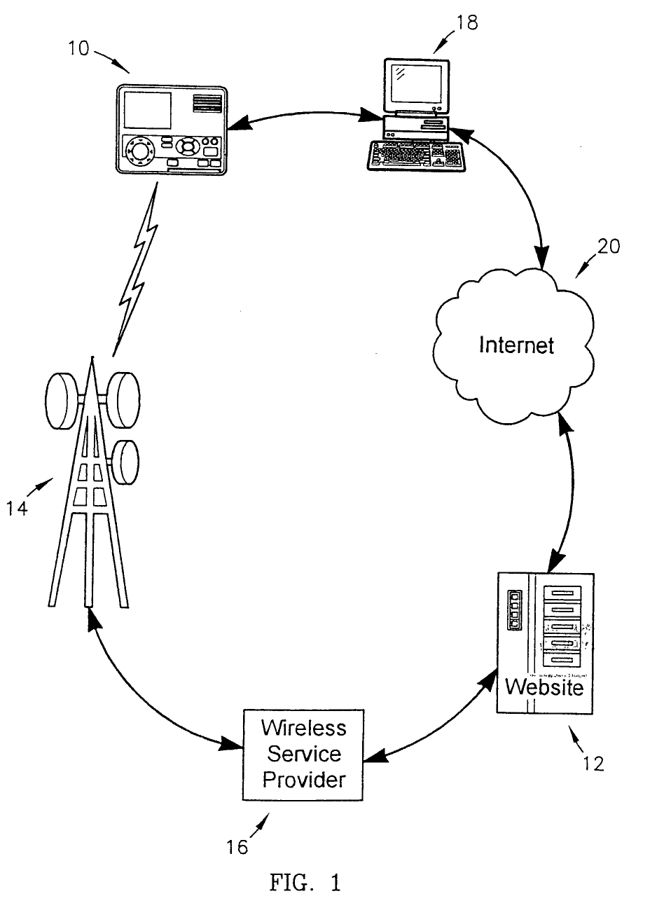

Referring to FIG. 1, a camera 10 in accordance with the present invention is illustrated along with communications and computing equipment which may be used to implement certain aspects of the invention. The preferred camera 10 is capable of capturing, modifying, and transferring a plurality of digital images to an Internet website 12. The camera 10 preferably transfers the images to the website 12 through a wireless connection to one of a plurality of wireless communications towers 14 operated by one or more wireless communication service providers 16.

The images may be in either still image or moving image formats. Since common moving image formats comprise several still images grouped in sequence, the term images used throughout this document will be understood to encompass both still images and moving images.

The website 12 may be hosted on a stand-alone server of the type commonly available from IBM, Compaq, or Sun Microsystems. Alternatively, the website 12 may include several interconnected servers. Additionally, the website 12 may include network attached storage (NAS) devices of the type commonly available from Snap and accessible by the server hosting the website 12. The images may be stored on any portion of the website 12 including any NAS devices.

The website 12 is preferably operated by a company that provides online data hosting services. The camera 10 and/or portions of the camera 10 may be sold through or for the company, allowing the camera 10 to be customized for use with the company's facilities. Additionally, the company may charge a user of the camera 10 a storage fee for storage of the images.

Furthermore, the website 12 is preferably segmented into a plurality of small user sites, with each user site dedicated to storing images for one camera 10. The website 12 may require the use of a password or other commonly used security technique in order to permit access to any of the images.

The service provider 16 may operate either an analog cellular system, a digital wireless telephone system, or a wireless wide area network (WAN) system, such as an IEEE 802.11 a compliant network. The service provider 16 may provide this connectivity between the camera 10 and the website 12 in exchange for compensation from the company, who may in turn charge a service fee to the user. Alternatively, the service provider 16 may charge the service fee directly to the user. In either case, the service fee may be a flat rate monthly fee or a usage fee dependant upon connectivity time or quantity of data transferred.

Additionally, the camera 10 may be connected to a personal computer (PC) 18 through either a traditional wired connection or a wireless local area network (LAN), such as an IEEE 802.11b network. The PC 18 is primarily used to update information stored in the camera 10, but may also be used to modify and transfer images to the website 12, in the traditional manner. As such, the PC 18 may connect to the website 12 through the Internet 20 or a traditional dial-up connection. Additionally, the PC may connect to the website 12 through the service provider 16. Furthermore, the PC 18 may receive updated information to be stored in the camera 10 through the Internet 20 or other means, such as, receiving computer readable medium through the mail.

While the camera 10 preferably operates in conjunction with the Internet 20, the camera 10 could also be used with any WAN or LAN. It is anticipated that this would only simplify certain functions of the camera 10 and is therefore not discussed. Additionally, this may allow the company and the service provider 16 to be the same entity. This may also not require the tower 14. Therefore, it is to be understood that any reference to the Internet 20, is meant to include any WAN or LAN.

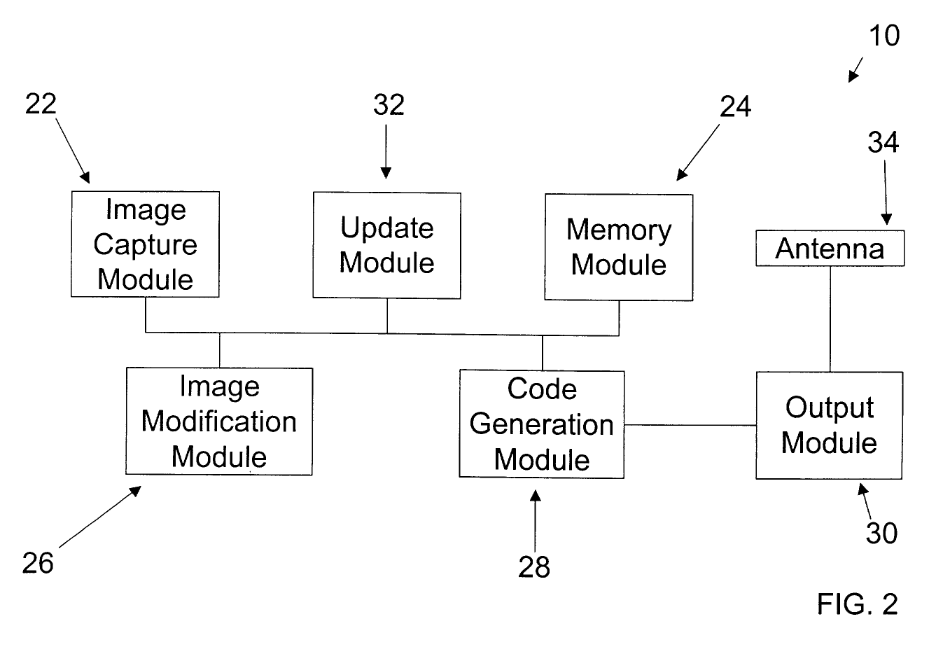

Referring also to FIG. 2, the camera 10 broadly comprises an image capture module 22 for capturing the images, a memory module 24 for storing the images, an image modification module 26 for modifying the images, a code generation module 28 for encapsulating the images in a block of browser compatible code, an output module 30 for connecting with and transferring the block of code to the website 12 through the service provider 16. The camera 10 also includes an update module 32 for updating information stored in the camera 10. Additionally, the camera 10 may include an output capable of direct connection to computer monitor and/or a television and an input capable of direct connection to a keyboard and/or a mouse. Together, the output and the input allow the user to interact with the camera 10 using a large screen and keyboard, thereby making this interaction more user-friendly.

Furthermore, the camera 10 preferably includes other features and accessories that are commonly available on digital cameras, such as, a view screen for viewing the images and a plurality of control buttons that allow the user to control the functionality of the camera 10. Additionally, the camera 10 may include common input/output ports, such as a serial port, a USB port, and/or a Firewire port.

In a preferred embodiment, the view screen is a touchscreen, such as those commonly available on personal data assistants (PDAs). While any number of control buttons may be used, the camera 10 preferably includes six control buttons. Together, the touchscreen and the control buttons allow the user to control the functionality of the camera 10 and may allow the user to access functionality independently developed by third parties.

The image capture module 22 is preferably similar to that of commonly available digital cameras and is activated by a shoot button that is preferably mounted on top of the camera 10. Specifically, the image capture module 22 is operable to create each digital image file representative of an object or objects the user wishes to capture when the shoot button is depressed. The image files are preferably created in a standard image file format, such as JPEG, TIF, GIF, BMP, or MPEG. The image capture module 22 stores the digital image files in the memory module 24.

The memory module 24 is preferably removable and preferably includes a utility section and an application section. The utility section is used to store the digital image files. The application section is preferably used to store information, such as, an IP address of the website 12. The application section may also be used to store pre-configured code segments for use with the browser. The code segments may include text and/or hyperlinks to graphics stored externally to the camera 10 and accessible by the website 12. The code segments may be written in any browser compatible programming language, such as, HTML, XHTML, VRML, and/or JAVA.

Information stored in the application section can preferably only be updated by the update module 32 through either the PC 18 or the output module 30. In this regard, updated information may be pushed from the company through the service provider 16 or the Internet 20 with or without the user's knowledge and/or permission each time the user connects the camera 10 to the website 12.

The image modification module 26 is used to modify a plurality of characteristics of each image according to input received from the user either through the control buttons, the keyboard, or the PC 18. The image modification module 26 edits the images by accessing and executing an embedded image modification application. The image modification application preferably operates similarly to image modification applications current available for the PC 18, but resides on the camera 10. As such, the image modification application is operable to be controlled through the touchscreen and the control buttons.

The characteristics preferably include resolution, size, shape, pan, zoom, and orientation of the image. Furthermore, the image modification module may also be used to accomplish other basic image editing functions, such as reducing red-eye.

As discussed above, the user may be charged for connectivity time or quantity of data transferred through the service provider 16. Additionally, the user may be charged for data stored on the website 12. Therefore, the ability to alter the digital image file size by modifying the resolution and/or the size of the image is a significant advantage and allows the user to control costs associated with use of the camera 10.

The code generation module 28 is used to generate the block of code for use with the browser and may be activated by a transfer button mounted on the camera 10. The code generation module 28 generates the block of code by accessing and executing an embedded code generation application. The code generation application preferably accesses a selected one of a plurality of predefined web page themes stored as code segments in the application section of the memory module 24. The code generation application inserts the digital image files into the selected theme. Together, the digital image files encapsulated in the selected theme form the block of code. The block of code may be written in any browser compatible programming language, such as, HTML, XHTML, VRML, and/or JAVA.

Each theme is basically a template for a resultant web-page and determines placement of the images and any text the user may wish to include. Each theme may also specify selection and placement of graphics stored externally to the camera 10 and accessible by the website 12. Furthermore, each template may specify colors and other characteristics of the resultant web-page.

Themes may be downloaded through the service provider 16, the Internet 20, and/or received on computer readable medium through the mail. Additionally, themes may be modified and/or created by the user using the control buttons mounted on the camera 10 and/or the PC 18. The user may store one or more themes in the camera 10 and may select one of the themes through the control buttons.

While it is anticipated that the user will prefer to encapsulate the images in one of themes, it is possible for the user to elect not to use any of the themes. In this case, the code generation module 28 generates the block of code containing only the digital image files and any code necessary for proper display of the images on the website 12, such as the IP address of the website 12 and information used to identify the user.

The output module 30 is used to connect the camera 10 with the cellular service provider 16 and preferably includes an antenna 34 and a CDMA and/or GPRS modem. The output module 30 connects with the website 12 at the IP address stored in the application section of the memory module 24 through the antenna 34, tower 14, and the service provider 16. This connection is initiated by depressing the transfer button. Once this connection has been established, the output module 30 modulates the block of code received from the code generation module 28 through the modem and sends the block of code to the website 12

The update module 32 is used to update information stored in the application section of the memory module 24, such as, the IP address and the code segments. The update module 32 is preferably the only way to update the information stored in the application section of the memory module 24 in order to prevent this information from becoming accidentally altered. The updated information will be used by the code generation module 28 and the output module 30 on the next and subsequent instances when the transfer button is depressed. Alternatively, in order to use the updated information, it may be necessary to turn the camera 10 off and then back on, reinitializing the camera 10 with the updated information.

While the present invention has been described above, substitutions may be made. For instance, the memory module 24, as described above may, in fact, comprise two modules. A first memory module may include the utility section and may be removable, allowing the utility section to be easily removed and/or upgraded. A second memory module may include the application section and may or may not be removable.

An anticipated advantage of the second memory module being removable is that this would allow for easy, frequent, and reversible updates to the information stored in the application section. For instance, the camera 10 may be used by two different users, each with a unique user site on the website 12 simply by replacing the second memory module. Images from each user may be directed to their unique user site using the same camera 10 and not requiring special procedures. Alternatively, a single user may use the camera 10 with two unique websites 12, each with a unique IP address stored in respective second memory modules.

Additionally, the view screen may be used to display information concerning connectivity time or quantity of data transferred through the service provider 16. This information may assist the user in monitoring costs associated with use of the camera 10.

Furthermore, connectivity through the service provider 16 may be handled on a pre-paid credit basis. In this case, the view screen may be used to display a number of remaining credits. The user may purchase additional credits either through the camera 10 or through any other commonly used means.

Finally, while the output module 30 has been described with the CDMA and/or GPRS modem allowing the camera 10 to be used with traditional cellular networks, other capabilities may be required. For example, as discussed above, the camera 10 may be used with any LAN or WAN. Therefore, the output module 30 may include any hardware and/or software required by the specific network chosen. These and other minor modifications are within the scope of the present invention.

The modules 22, 26, 28, 30, 32 described above may be implemented by one or more embedded computer processors. The processor may allow the camera 10 to include functionality normally reserved for the PC 18. For instance, as discussed above, the camera 10 may be connected to a computer monitor and a keyboard, allowing the user to more easily interact with the camera 10. Additionally, the processor may allow the camera 10 to include the browser, thereby allowing the user to see how the images will look on the website 12 before the images are transferred.

Both the image modification application and the code generation application are preferably stored in the application section of the memory module 24.

Therefore, these applications may be updated through the update module 32.

Alternatively, these applications may be stored in other areas of the camera 10 either allowing or preventing them from being modified.

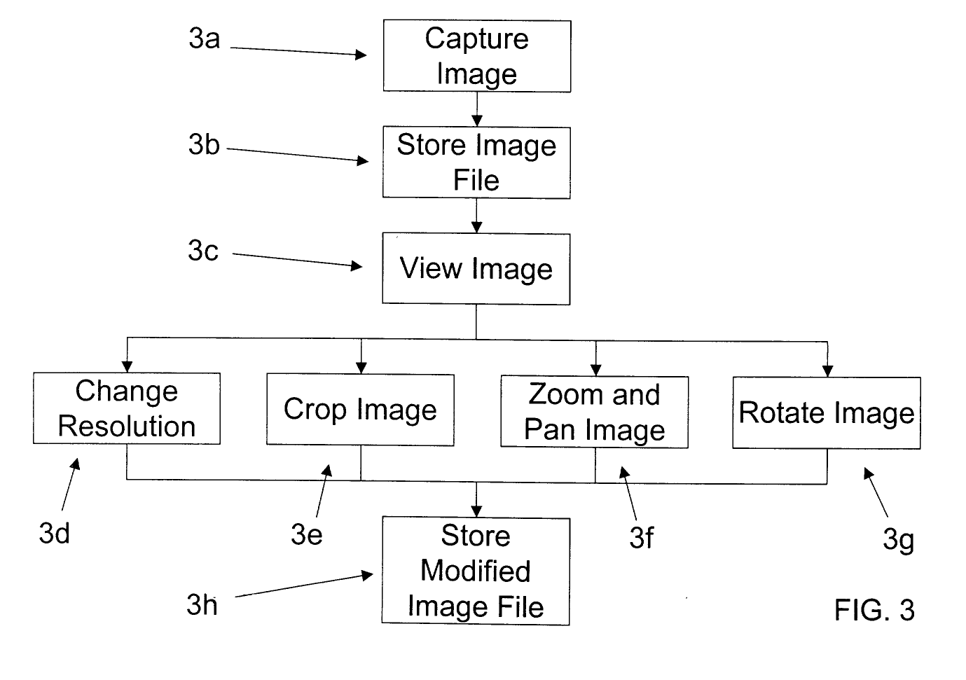

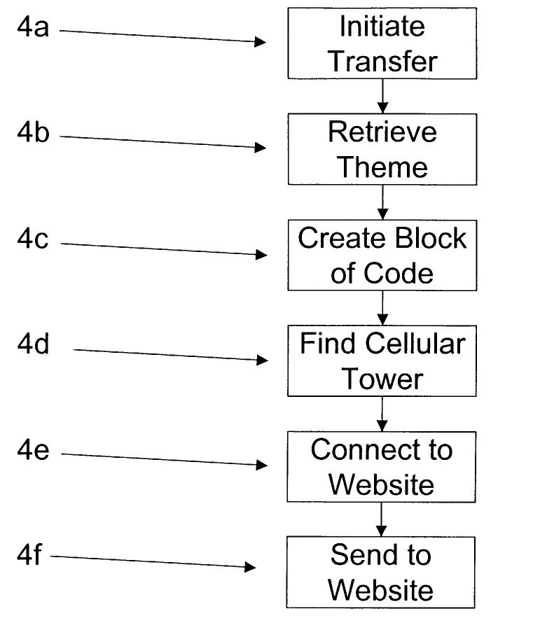

The flow charts of FIG. 3 and FIG. 4 show the functionality and operation of a preferred implementation of the present invention in more detail. In this regard, some of the blocks of the flow charts may represent a module segment or portion of code of a program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

In use, referring to FIG. 3, the user captures the image by aiming the camera 10 at the object he or she wishes to capture and depressing the shoot button, as depicted in step 3a. The image capture module 22 creates and stores the digital image file representative of the object in the utility section of the memory module 24, as depicted in step 3b. The image is then displayed on the view screen where the user may view the image, as depicted in step 3c.

If the user wishes, he or she may modify the image. One reason the user may wish to modify the image is to reduce the image file's size, enabling faster transfer to the website 12. The user may adjust the resolution of the image using the control buttons, as depicted in step 3d. The user may also crop the image adjusting the size and/or shape of the image using the control buttons, as depicted in step 3e. The user may also zoom and/or pan adjusting the center of the image using the control buttons, as depicted in step 3f. The user may also rotate the image adjusting the orientation of the image using the control buttons, as depicted in step 3g.

When the user is done making modifications, the modified image is stored in the memory module 24, as depicted in step 3h. The user may, at any time, revert back to step 3c and make any additional modifications he or she wishes following the steps 3d-3h.

Referring to FIG. 4, when the user wishes to transfer images to the website 12, he or she initiates the transfer by depressing the transfer button, as depicted in step 4a. The code generation module 28 retrieves any selected theme stored in the application section of the memory module 24, as depicted in step 4b. The code generation module 28 then creates the block of code comprising the images according to the theme, as depicted in step 4c. The output module 30 then searches for the tower 14 with the antenna 34, as depicted in step 4d. Once contact is established with the service provider 16, the output module 30 attempts to establish a connection with the website 12 at the IP address stored in the application section of the memory module 24, as depicted in step 4e. The output module 30 then sends the block of code received from the code generation module 28 to the website 12 through the cellular service provider 16, as depicted in step 4f. The user may then view the images on the website 12 using the browser through the Internet 20.

Having thus described a preferred embodiment of the invention, what is claimed as new and desired to be protected by Letters Patent includes the following:

1. A digital camera operable to capture and transfer a plurality of digital images to an Internet website where the images may be viewed with an Internet web browser, the camera comprising:
a memory module for storing each image in the form of one of a plurality of digital image files;
an image capture module operable to create each digital image file and store the digit image files in the memory module; and
an output module operable to connect the camera with a wireless service provider for transferring the digital image files to the website.

2. The camera as set forth in claim 1, further comprising an image modification module operable to modify at least one characteristic of each image.

3. The camera as set forth in claim 2, wherein the characteristic is selected from the group consisting of: resolution, size, shape, pan, zoom, and orientation.

4. The camera as set forth in claim 1, further comprising an onboard browser operable to allow a user to see how the images will appear on the website before they are transferred.

5. The camera as set forth in claim 1, wherein the memory module includes an application section for storing an IP address of the website.

6. The camera as set forth in claim 5, wherein the application section can only be modified through an update module operable receive updated information to be stored in the application section.

7. The camera as set forth in claim 5, further comprising a code generation module operable to generate a block of code for use with the browser, wherein the block of code includes the digital image files.

8. The camera as set forth in claim 7, wherein the application section also stores a plurality of code segments.

9. The camera as set forth in claim 8, wherein the code segments are used by the code generation module in creating the block of code.

10. The camera as set forth in claim 7, wherein the block of code also includes hypertext links to graphics stored externally to the camera.

11. A digital camera operable to capture, prepare, and transfer a plurality of digital images to an Internet website where the images may be viewed with an Internet web browser, the camera comprising:
a memory module for storing each image in the form of one of a plurality of digital image files;
an image capture module operable to create each digital image file and store the digit image files in the memory module;
a code generation module operable to generate a block of code for use with the browser, wherein the block of code includes the digital image files; and
an output module operable to connect the camera with a wireless service provider for transferring the block of code to the website.

12. The camera as set forth in claim 11, further comprising an image modification module operable to modify at least one characteristic of each image.

13. The camera as set forth in claim 12, wherein the characteristic is selected from the group consisting of: resolution, size, shape, pan, zoom, and orientation.

14. The camera as set forth in claim 11, further comprising an onboard browser operable to allow a user to see how the images will appear on the website before they are transferred.

15. The camera as set forth in claim 11, wherein the memory module includes an application section for storing an IP address of the website.

16. The camera as set forth in claim 15, wherein the application section also stores a plurality of code segments.

17. The camera as set forth in claim 16, wherein the code segments are used by the code generation module in creating the block of code.

18. The camera as set forth in claim 15, wherein the application section can only be modified through an update module operable to receive updated information to be stored in the application section.

19. The camera as set forth in claim 11, wherein the block of code also includes hypertext links to graphics stored externally to the camera.

20. A digital camera operable to capture, modify, and transfer a plurality of digital images to an Internet website where the images may be viewed with an Internet web browser, the camera comprising:
a removable memory module including
an application section for storing an IP address of the website and a plurality of HTML segments, and
a utility section for storing each image in the form of one of a plurality of digital image files;
an image capture module operable to create each digital image file in a standard image file format and store the digital image files in the memory module;
an image modification module operable to modify a plurality of characteristics of each image according to input received from a user through a plurality of control buttons mounted on the camera, wherein the characteristics are selected from the group consisting of—resolution, size, shape, pan, zoom, and orientation;
a code generation module operable to generate a block of code according to the HTML segments for use with the browser, wherein the block of code includes the digital image files and hypertext links to graphics stored externally to the camera;
an output module operable to connect the camera with a wireless service provider for transferring the block of code to the website at the IP address;
an update module operable to update the IP address and the HTML segments; and
an onboard browser operable to allow a user to see how the images will appear on the website before they are transferred.
